(19) United States
(12) Patent Application Publication
(10) Pub. No.: US 2022/0089842 A1
(43) Pub. Date: Mar. 24, 2022

(54) STARCH COMPOSITION

(71) Applicant: KEMIRA OYJ, Helsinki (FI)

(72) Inventor: Asko KARPPI, Espoo (FI)

(21) Appl. No.: 17/429,140

(22) PCT Filed: Feb. 6, 2020
(86) PCT No.: PCT/FI2020/050072

§ 371 Date: Aug. 6, 2021

(30) Foreign Application Priority Data
Feb. 8, 2019 (FI) 20195089

(51) Int. Cl. C08L 3/04; D21H 17/29; D21H 21/16; D21H 21/10; D21H 21/18

(52) U.S. Cl. CPC C08L 3/04; D21H 17/29; D21H 21/18; D21H 21/10; D21H 21/16

(57) ABSTRACT

The present invention relates to an aqueous composition of dissolved starch, use of it and compositions comprising the same. The composition has good handling properties and viscosity stability also in elevated starch concentrations.

### FIELD OF INVENTION

The present invention relates to an aqueous composition of dissolved starch, use of it and compositions comprising the same.

### BACKGROUND

Starch is a well-known additive in papermaking, and one of the oldest dry-strength agents still in use. Starch is typically used in the wet end of the paper machine, where it may be added to the papermaking fibre stock at various places before the headbox for improving paper dry strength, for controlling dusting and linting, or for retention and drainage. Other common applications of starch in papermaking include use in surface sizing compositions, or as binders in coating colour compositions.

Typical commercial starches used in paper making are dry powders, which must be dissolved in water before use in the application. Dry starches are typically dissolved by cooking process at the site of application just before use. When dry starch starts to swell and dissolve in water, at first viscosity typically increases, then individual starch molecules detach from each other, which can be observed as decrease in viscosity. Starches are most typically dissolved by jet-cooking process, in which aqueous starch slurry is contacted with steam and dissolving takes place in a tube. Typical temperature in jet-cooking process is about 120-130° C. sometimes up to 140° C. Process time is about 1-2 minutes. Undegraded starches are typically cooked at concentration of maximum 4-6 wt.-%. Temperatures of 140° C. and above are avoided as starch start to get significantly thermally degraded due to hydrolysis of glycosidic bonds. Starches may also be dissolved by cooking at atmospheric pressure, which typically involves heating to above 90° C. and keeping there for about 25 min. Here, the starch concentration is typically lower than in jet-cooking, often about 1 wt.-%. After the starch has been dissolved, it is common to dilute it below 1 solids content before dosing to the papermaking fibre stock, to ensure homogeneous mixing to the fibre stock.

While starch products in dry powder form have relatively good shelf-life, once the dry starch has been dissolved in water, it should be used soon. This is because in aqueous environments starch is vulnerable to microbial spoilage, which cannot be fully addressed by adding biocides, as the remaining microbial enzyme activity may continue degrading the starch even after killing the microorganisms. Storing the dissolved starch at decreased temperature is not a satisfactory solution either due to viscosity instability. Aqueous compositions of dissolved starch are prone to retrogradation, especially at lower temperatures. During retrogradation dissolved starch gets reorganized, the starch molecules reform into new crystalline complexes and the water bound to the starch is released. In aqueous compositions having low starch content, retrogradation may be seen as increase in turbidity or formation of precipitates that may sediment to the bottom of the container. At higher starch contents, retrogradation may even cause the aqueous compositions to form gel lumps or even continuous thickened gel. As can be understood, the increase in turbidity, precipitation, and gelling are not desired. While slight increase in turbidity or precipitates do not always render the composition completely unusable, its efficiency may be reduced and higher dosages needed. Additionally, there are applications where even small amounts of gel lumps may block equipment e.g filters or compromise critical end-product properties. Thickening on the other hand has detrimental effect both on performance and handleability/pumpability of the compositions. Starch retrogradation may be observed and analysed by various methods known in the field.

Even though starch products are typically dry powders, also aqueous compositions of dissolved starch are available on the market. These products are ready-to-use products for special applications, and may be especially beneficial e.g. at small paper mills with limited space for the dissolving equipment and tanks, and when the investment cost for the equipment cannot be justified.

Thus, there is a continued demand for aqueous compositions of dissolved starch having reasonable starch concentration and stability, especially viscosity stability, allowing reduced transportation cost and improved shelf life.

### SUMMARY

The present disclosure generally relates to aqueous compositions of dissolved starch having relatively high average molecular weight and improved stability, especially against retrogradation, and that are usable for paper and board applications.

First object of the present invention is an aqueous composition of dissolved starch having characteristics depicted in claim 1.

The second object of the present invention is a use of the composition described here as a paper strength agent, as a papermaking retention and drainage aid, as a flocculant, as a paper sizing agent, as a protective colloid, as an emulsifier, as a rheology modifier, as a binder.

The third object is a sizing formulation, e.g. ASA emulsion, comprising the composition described here.

### DETAILED DESCRIPTION

Desired properties for ready-to-use dissolved starch products include a reasonably high starch concentration to reduce transportation cost, a reasonable viscosity for easy handling and pumping, and sufficient stability, especially microbial stability and viscosity stability, to allow transportation to site of use. However, these properties are not easy to meet due to the microbial vulnerability, retrogradation tendency, high viscosity of compositions having elevated starch contents, and limitations of the most common starch dissolving methods.

It has now surprisingly been found that when starch granules in an aqueous slurry are gradually brought together with an aqueous flow having an elevated temperature the starch gelatinizes. When said gelatinized starch it subjected to a high shear dispersive mixing a homogenous mixture having a viscosity typically below 20 000 millipascal seconds (mPas) allowing easy handling and pumping with relatively high starch dry matter content can be obtained. The resulting aqueous composition of dissolved starch is homogenous and may be transferred by using existing pumping equipment and pipelines, without danger of jamming or clogging. It has also improved resistance towards retrogradation and improved viscosity stability during storage. Surprisingly now it is possible to produce an aqueous starch composition having reasonably high starch content and good stability even using starch with reasonable cationicity. The present invention relates to an aqueous composition of dissolved starch, wherein the composition comprises at least 12 weight-% of dissolved cationic starch, said starch having
a viscosity of at least 500 mPas, as measured at 25° C. from 12 weight-% aqueous solution using Brookfield LV-DV1 viscometer,
degree of cationic substitution (DScat) of 0.02-0.15, or 0.03-0.09, and
an amylopectin content of at least 90 weight-% of dry starch

and wherein the composition has a viscosity of 500 to 15 000 mPas as measured at 25° C. using Brookfield LV-DV1 viscometer. As used herein, by viscosity is meant a viscosity determined at 25° C. by Brookfield LV-DV1 viscometer, equipped with a small sample adapter, and using spindle 31 and maximum rotation speed allowed by the equipment. Additionally, when referring to viscosity of an aqueous composition, it is meant the viscosity of the composition as it is, thereby reflecting e.g. handleability of the composition, and when referring to viscosity of dissolved cationic starch, it is meant the viscosity measured at a constant starch concentration of 12 weight-% in deionized water, thereby reflecting the molecular weight of the dissolved cationic starch.

In this connection the expression “an aqueous composition of dissolved starch” means an aqueous composition comprising dissolved starch. Such composition may contain minor amounts of incompletely dissolved or partially dissolved starch material, or/and other components used within the field. Herein the aqueous composition may sometimes be referred to as solution. However, in some embodiments, especially at higher starch contents, the composition may have storage modulus slightly larger than loss modulus, indicating transition from fluid flow like behaviour towards solid elastic behaviour, i.e. may meet the scientific definition of gel.

In one embodiment the aqueous composition of dissolved starch is substantially homogeneous. Homogeneity may be measured by separating the gel (gel lumps) by e.g. sieving a starch composition diluted to about 9 wt.-% starch content with de-ionized water and using a 300 μm plastic wire and above that pre-dried filter paper having a pore size of about 22 μm at 3 bar pressure to separate gel from said composition. A complete protocol is described in Example 6.

In one embodiment said homogeneous composition has a gel content of less than 0.3 wt.-%, preferably less than 0.2 wt.-% and more preferably less than 0.1 wt.-% measured as a share of dry starch of the composition (starch of gel/starch of composition).

Cationic starches can conveniently be used in paper and board manufacturing applications and they have a good interaction with (typically anionic) fibre material. Cationic starch is suitable for use in the dry strength compositions and may be obtained by cationising starch by any suitable method. Preferably cationic starch is obtained by using 3-chloro-2-hydroxypropyl-trimethylammonium chloride or 2,3-epoxypropyltrimethylammonium chloride. It is also possible to cationise starch by using cationic acrylamide derivatives, such as (3-acryl-amidopropyl)-trimethylammonium chloride. Various methods for cationisation of starch are known for a person skilled in the art.

The cationic starch may be obtained using cationisation as the sole chemical derivatization of starch, and the cationic starch is thus non-cross-linked, non-grafted, or it has not been otherwise chemically modified.

In one embodiment the cationic starch has a viscosity of 500-2000 mPas, preferably of 500-1500 mPas, as measured at 25° C. from 12 weight-% aqueous solution using Brookfield LV-DV1 viscometer.

It is desired that the dissolved cationic starch has relatively high molecular weight. This is beneficial especially for wet end applications at paper and board machines, as the higher molecular weight may improve retention of the starch to the fibres, thereby improving the effect on paper strength. Additionally, retention of other components present in the fibre stock may be enhanced by the higher molecular weight of the starch. The enhanced retention contributes to cleaner water circulation, including lower BOD (biochemical oxygen demand)) and COD (chemical oxygen demand). The relatively high molecular weight is reflected by the viscosity of at least 500 mPas, as measured at 25° C. from 12 weight-% aqueous solution of the starch using Brookfield LV-DV1 viscometer. In practice this viscosity level means that the cationic starch has not been hydrolyzed extensively, e.g. by oxidative, thermal, enzymatical and/or acid treatment that are commonly used when manufacturing degraded starches, or even dextrines, e.g. for coating pastes and other uses where low viscosity and low molecular weight starch is needed.

In one embodiment the starch in the aqueous starch composition comprises starch units of which at least 85 weight-%, even more preferably at least 90 weight-%, sometimes even more preferably at least 95 weight-%, have an average molecular weight (MW) over 20 000 000 g/mol, preferably over 50 000 000 g/mol, more preferably over 100 000 000 g/mol, sometimes even over 200 000 000 g/mol.

In an embodiment, the aqueous composition comprises less than 5 weight-%, preferably less than 4 weight-%, more preferably less than 3 weight-%, or even less than 2 weight-%, calculated from the dry weight of the dissolved starch, of starch oligomers having weight-average molecular weight<5000 g/mol. In an embodiment, the aqueous composition comprises less than 5 weight-%, preferably less than 4 weight-%, more preferably less than 3 weight-%, or even less than 2 weight-%, calculated from the dry weight of the dissolved starch, of starch oligomers having weight-average molecular weight<10 000 g/mol.

In paper making, the lower starch oligomer content of the composition is expected to be beneficial especially for paper strength, and quality of circulating waters, as the small oligomers have lower or no effect on paper strength, and are difficult to retain to the fibres, thereby easily ending up into the circulating waters and increasing BOD/COD, which may necessitate higher biocide dosages to the process. The lower starch oligomer content may also be beneficial for sizing formulations, as high dispersity index of the starch is believed to deteriorate stability of sizing formulation.

Starch having a degree of cationic substitution (DScat, indicates the number of cationic groups in the starch on average per glucose unit) in the range of 0.02 to 0.15, more preferably 0.03-0.09 provides an enhanced viscosity stability for the composition.

In one embodiment the composition comprises 12 to 30 weight-% of the dissolved cationic starch derived from non-degraded starch which has not intentionally been degraded. In one embodiment the composition comprises at least 12 wt.-%, 14 wt.-%, 16 wt.-% or 18 wt.-% of dissolved cationic starch by dry weight. In one embodiment the composition comprises less than 30 wt.-%, 28 wt.-%, 26 wt.-%, 24 wt.-% or 22 wt.-% of dissolved cationic starch by dry weight. In one embodiment the composition comprises 20 to 24 wt.-% or 20 to 22 wt.-% of dissolved cationic starch by dry weight. In one embodiment said starch is derived from non-degraded starch which has not intentionally been degraded. A high content of dry matter is beneficial in a transportation and a storage. The aqueous starch composition of the invention may be diluted on-site to a desired final concentration prior to a use.

In one embodiment the starch has a charge density (CD) of 0.1 to 1.0 meq/g (dry solids), preferably 0.2 to 0.8 meq/g (dry solids), measured at pH 7. Measured charge density values are calculated per weight as dry. Above defined charge densities enhance retaining of the starch on anionic components present e.g. in the papermaking fibre stock. It is also low enough to allow elevated dosages of the composition with minimal risk of over-cationization of the fibre stock.

In one embodiment the cationic starch has an amylopectin content of at least 95 weight-%, preferably at least 98 weight-%, of dry starch. In one embodiment the starch has an amylopectin content of 100% of dry starch. In another embodiment the cationic starch is cationic waxy starch. A share of amylopectin starch is given as a percentage of the starch dry weight. Preferably the starch of the aqueous starch composition originates from waxy corn starch and/or waxy potato starch. Amylopectin contents for commercial starches are often provided by the starch manufacturers. The amylopectin content may also be determined by using the iodine-binding method disclosed by Zhili Ji et al. in Food Hydrocolloids 72 (2017) 331-337, under 2.1. A high amylopectin content is beneficial for the viscosity stability of dissolved starch during a storage. An aqueous starch composition having a high amylopectin starch content has an enhanced resistance to a retrogradation. Large molecular size improves starch retention to the fibrous material.

In one embodiment the composition has a viscosity of 1000 to 12 000 mPas, or 2000 to 10 000 mPas, as measured at 25° C. using Brookfield LV-DV1 viscometer. In one embodiment the aqueous composition of dissolved starch has an initial viscosity of 2000 to 8000 mPas. Such a viscosity allows easy handling, but the water content of the composition is still relatively low. A relatively high dry matter content and a low water content allow lower transportation and storage volumes.

For example, the viscosities of the composition described here may be 3 000 to 6000 mPas for a composition having 20 to 22 wt.-% of cationic dissolved starch by dry weight or 6000 to 10 000 mPas for 22 to 25 wt.-% of cationic dissolved starch by dry weight and even up to 15 000 mPas or 12 000 mPas for a composition having about 30 wt.-% of cationic dissolved starch by dry weight. The viscosity of the composition impacts on handling and e.g. pumpability of the composition. While all the viscosities presented herein are handleable, the specific exemplary or preferred viscosity ranges are especially easy to handle and pump with commonly available devices.

The present composition has enhanced viscosity stability over broad temperature range, which is especially beneficial for industrial products transported and stored in containers outdoors, and thus exposed to various temperatures, and even to vast temperature changes.

The present composition has enhanced stability against retrogradation, that is generally known to be enhanced at lower temperatures. This is especially beneficial property for aqueous starch products containing or exposed to microbial contamination, including living microbes, spores and/or microbial enzymes, as the microbial spoilage may effectively be reduced or minimized at low temperatures. While biocides may be effective for killing of living or viable microorganisms, they may be ineffective e.g. against spoilage caused by residual microbial enzymes present in the product. Viscous products have an additional challenge as condensation water that is typically built in closed containers, may accumulate on top of the viscous product, and generate a layer that is prone to microbial growth, even when the viscous product itself contains a biocide. Additionally, some biocides may lose their biocidal power over time, and thereafter be inefficient e.g. against germination of spores. For some applications it may be desired or even required not to use biocides at all, or only to limited extent. As starch originates from natural sources, it is hardly available without some microbial contamination. For large volume industrial products complete sterilization and aseptic packaging is not a viable option. Due to the improved stability against retrogradation, the present compositions of dissolved starch may be subjected to lower temperatures, which provides a huge improvement to overall stability of the compositions, thereby overcoming many of the above challenges and limitations.

An increase in turbidity and/or loss of homogeneity may be used as indicators for poor retrogradation stability.

In one embodiment the viscosity of the composition after storage of at least 40 days, at a temperature of 25° C., differs at most 30%, preferably at most 20%, more preferably at most 15%, from day 0 viscosity of the composition, as measured at 25° C. using Brookfield LV-DV1 viscometer.

In this connection the expression “day 0 viscosity” or “initial viscosity” means the viscosity of the composition as measured immediately of within less than 6 hours from the preparation of the composition.

In one embodiment the viscosity of the composition after storage of at least 40 days at a temperature of 25° C., differs at most 30%, preferably at most 20%, more preferably at most 15%, from day 0 viscosity of the composition, as measured at 25° C. using Brookfield LV-DV1 viscometer.

In one embodiment the viscosity of the composition after storage of at least 60 days at a temperature of 25° C., differs at most 30%, preferably at most 20%, more preferably at most 15%, from day 0 viscosity of the composition, as measured at 25° C. using Brookfield LV-DV1 viscometer.

In one embodiment the viscosity of the composition after storage of at least 90 days or even at least 120 days, at a temperature of 25° C., differs at most 30%, preferably at most 20%, more preferably at most 15%, from day 0 viscosity of the composition, as measured at 25° C. using Brookfield LV-DV1 viscometer.

In an embodiment the viscosity of the composition after storage of 20 days, preferably of 30 days, more preferably of 60 days, at a temperature of 15° C., differs at most 30%, preferably at most 20%, more preferably at most 15%, from day 0 viscosity of the composition, as measured at 25° C. using Brookfield LV-DV1 viscometer.

In an embodiment the viscosity of the composition after storage of 20 days, preferably of 30 days, more preferably of 60 days, at a temperature of 10° C., differs at most 40%, preferably at most 30%, more preferably at most 20%, from day 0 viscosity of the composition, as measured at 25° C. using Brookfield LV-DV1 viscometer.

In an embodiment the viscosity of the composition after storage of 10 days or of 20 days, preferably of 30 days, more preferably of 60 days, at a temperature of 5° C., differs at most 40%, preferably at most 30%, more preferably at most 20%, from day 0 viscosity, as measured at 25° C. using Brookfield LV-DV1 viscometer.

In this connection the difference (change of viscosity) is measured by comparing the viscosity at day 0 (initial viscosity) and the viscosity measured in another day, such as day 40. During a storage, the viscosity of the aqueous composition of dissolved starch may increase or decrease.

In one embodiment the composition has a pH of at least 4, preferably in the range of 4-10, more preferably in the range of 4-9. pH above 4 may reduce or even avoid acid hydrolysis of the glycosidic bonds in the starch. These embodiments may provide the benefits of improved shelf life and viscosity stability of the composition, and even improved performance in application due to reduced degradation of starch molecular weight.

In one embodiment the composition further comprises up to 20 weight-%, based on weight of dissolved cationic starch (dry/dry), of one or more additives, such as preservatives, biocides, stabilizers, antioxidants, pH adjusting agents, buffers or the like. In another embodiment the aqueous composition of dissolved starch further comprises up to 15 wt.-% based on weight of dissolved cationic starch (dry/dry), or up to 10 weight-%, of one or more auxiliaries or additives, such as preservatives, biocides, stabilizers, antioxidants, pH adjusting agents, or the like. Examples of such auxiliaries or additives include polymers commonly used e.g. as stabilizers, including polyvinylalcohol (PVA), urea, polyethylene oxide (PEO). PVA may improve the stability of the viscosity, urea may be used to adjust the viscosity level.

The aqueous compositions of dissolved starch are suitable for various uses in different industries, for example as flocculants in solid-liquid separation e.g. in papermaking, sludge dewatering, water treatment etc, as a protective colloid, as an emulsifier, as a rheology modifier, or as a binder e.g. in papermaking, but also in paints, coatings, adhesives, construction industry, textiles, oilfield applications etc. In one embodiment the aqueous compositions of dissolved starch is used as a paper strength agent, as a papermaking retention and drainage aid, as a flocculant, as a paper sizing agent, as a protective colloid, as an emulsifier, as a rheology modifier, as a binder. In one embodiment the aqueous starch composition is used in sizing emulsions, such as ASA (alkenyl succinic anhydride), AKD (alkyl ketene dimer) or rosin emulsions, especially in ASA emulsions, as a protective colloid, emulsifier or stabilizing polymer, and/or for improving the retention of an internal sizing agent.

The aqueous composition of dissolved starch described here may be produced by enriching a feed of at least partially gelatinized aqueous starch having elevated temperature with an aqueous starch slurry having initial temperature below gelatinization temperature of starch used. The feeds are brought together and resulting mixed feed is subjected to a high shear dispergation after controlled contact time and in temperature allowing gelatinization of starch used. Dispergation controls the viscosity of the feed. Dispersed feed may be subjected to further dispergation steps and/or brought together with starch slurry until desired starch dry matter and viscosity are reached.

The aqueous composition of dissolved starch comprising at least 12 wt-% starch (by dry weight) described here may be produced using the following steps:
a) providing a feed of an aqueous starch slurry having a temperature at least 5° C., preferably at least 10° C. below the gelatinization temperature of the starch (used in said slurry); and
b) bringing said feed (“slurry feed”) together with an aqueous feed having an elevated temperature being at least 60° C. to form a mixed feed; and
c) subjecting said mixed feed to a dispergation to reduce the viscosity of said mixed feed.

In one embodiment the starch used in a method for producing the composition is so called non-degraded starch. In this connection the expression “non-degraded starch” means that the starch molecules have not been intentionally degraded by chemical reactions (such as an acid hydrolysis or an oxidation), by an enzymatic hydrolysis or by a thermal degradation. High initial molecular weight and the method disclosed here allow producing a composition comprising dissolved starch with high molecular weight being reflected e.g. by viscosity properties which may be a viscosity of at least 500 mPas, as measured at 25° C. from 12 weight-% aqueous starch solution using Brookfield LV-DV1 viscometer.

In step b) the flow of the slurry feed and the aqueous feed having an elevated temperature are arranged to enable a sufficient mass and heat transfer between said feeds resulting in at least partial gelatinization of the starch in the resulting mixed feed. This may be done by controlling flow rates and bilateral assembly of the conduits.

Also a static mixing element or a dynamic mixer may be used. The delay time of the mixed feed may be about 1 to 30 seconds before the formed gel enters the dispergation step. The gelatinization takes place as the temperature of the mixed feed reaches the gelatinization temperature of the starch.

In one embodiment the mixed feed is lead to a heated dissolution tank and then again brought together with a starch dispersion and subjected to dispergation.

In one embodiment the temperature of the aqueous feed is 95 to 99° C.

In one embodiment the starch slurry contains 20 to 42 wt.-% starch (as dry matter). Starch in said slurry may be in granular or powder form or as a dispersion. A part of the starch in the slurry may be swelled.

In one embodiment the dispergation is performed using a circumvential speed of at least 25 m/s, preferably at least 50 m/s. The dispergation step separates entangled starch molecules from the gelatinized/gelatinizing starch feed and reduces viscosity with a minimal hydrolysis. In addition, the amount on oligomers which are forming during dissolving stage is expected to be minimal as temperature is low for starch dissolving process and process time is short.

Without wishing to be bound by any theory it is believed that a dissolving method using high shear mechanical treatment at elevated starch content, and at most moderate thermal treatment, causes the entangled starch molecules to break predominantly at and between the entanglement points, i.e. from the middle of the chains, instead of chopping the molecules randomly, including at the chain ends. This is expected to result in lower starch oligomer content in the dissolved starch compared to high temperature, enzymatic, oxidative and/or acid hydrolysis treatments.

In one embodiment the aqueous feed is obtained from a dissolution tank having a temperature of 60 to 99° C. and the mixed feed after dispergation is circulated back to said tank. In such embodiment gelatinised or gelatinising heated aqueous starch circulates via a dissolution tank and a dispergation step. Said aqueous composition of dissolved starch is enriched by starch slurry introduced to the circulation before each dispergation step. Temperatures above 99° C. may result starch hydrolysis and boiling of the solution(s) and should be avoided.

A feed starting from a heated dissolving tank is brought together with a slurry feed to form a gelatinizing mixed feed which is then subjected to dispergation and returned to dissolving tank. Mixing the slurry feed and the aqueous feed having an elevated temperature results in gelatinization of the starch granules before the dispergation step. A dispergation treatment reduces the viscosity of the gelatinized feed, which is then circulated back to the heated tank for use as aqueous feed now having an elevated starch content. In other words, there will be a circulating feed of at least partially gelatinized heated aqueous starch solution which is enriched by starch slurry feed introduced to said circulation so that the dispersed granules are gelatinized before the dispergation step.

This allows increasing the starch content of the resulting aqueous composition of dissolved starch and maintaining the viscosity in level allowing pumping the composition with regular equipment. When the temperature of the overall process is maintained below 99° C. also the starch hydrolysis is minimized.

The features of the method described here are applicable also to the composition described and claimed.

The invention is illustrated below by the following non-limiting examples. The embodiments given in the description above and the examples are for illustrative purposes only, and that various changes and modifications are possible within the scope of the invention.

### EXAMPLES

### Example 1: Dissolving of Cationic Starch and Storage Stability Test at Different Temperatures

238 g cationic waxy potato starch (dry content 82.5 wt-%, DS(Cat) 0.07) was slurried in 322 g tap water. pH of the slurry was 8.5 at 25° C. 440 g tap water was heated in a 2 liter kettle to 95° C. The hot water in the kettle was dispersed with Kady LT 2000 rotor stator high speed dispersion lab mill dispergator by frequency of 25 Hz. The starch slurry was poured into the hot water within 3 min time while dispersing with Kady dispergator at 25 Hz frequency. When all the slurry is added then frequency of Kady dispergator was increased to 30 Hz and the mixture was dispersed for 1 min. The formed starch composition was cooled to 25° C. The cooled starch composition was preserved by adding 1.4 g chloromethylisothiazolinone/methylisothiazolinone mixture (CIT/MIT) preservative product with active content 2.1 wt-%. The starch composition had the following characteristics: Dry content 20 wt.-%, viscosity at 25° C. 3430 mPas and pH 8.3. The starch composition was divided to three parts, and each sample was stored at 5° C.; 25° C. and 35° C. for 120 days to evaluate viscosity stability of the starch composition at different temperatures. Viscosity and pH were monitored during storage. Results of the storage test are shown in the table 1. Viscosity change compared to the start value was calculated and the viscosity change results are shown in the table 2.

TABLE 1
Viscosity and pH of dissolved starch composition at 5, 25 and 35° C.

| Storage | Storage at 5° C. | | Storage at 25° C. | | Storage at 35° C. | |
|---|---|---|---|---|---|---|
| time | Viscosity at | | Viscosity at | | Viscosity at | |
| Days | 25° C., mPas | pH | 25° C., mPas | pH | 25° C., mPas | pH |
| 0 | 3430 | 8.29 | 3430 | 8.29 | 3430 | 8.29 |
| 14 | 3440 | 8.24 | 3475 | 8.07 | 3430 | 7.89 |
| 22 | 3535 | 8.25 | 3425 | 8.13 | 3320 | 7.88 |
| 30 | 3530 | 8.03 | 3490 | 7.67 | 3375 | 7.75 |
| 51 | 3490 | 7.95 | 3495 | 7.85 | 3290 | 7.62 |
| 120 | 3590 | 7.78 | 3570 | 7.64 | 3290 | 7.28 |

TABLE 2
Viscosity change during storage at 5, 25 and 35° C.

| | Storage at 5° C. | Storage at 25° C. | Storage at 35° C. |
|---|---|---|---|
| Storage | Viscosity change | Viscosity change | Viscosity change |
| time | compared to start | compared to start | compared to start |
| Days | value, % | value, % | value, % |
| 0 | 0 | 0 | 0.0 |
| 14 | 0.3 | 1.3 | 0.0 |
| 22 | 3.1 | −0.1 | −3.2 |
| 30 | 2.9 | 1.7 | −1.6 |
| 51 | 1.7 | 1.9 | −4.1 |
| 120 | 4.7 | 4.1 | −4.1 |

Results of the example 1 show that viscosity of the cationic waxy potato starch composition at 20 wt-% is at moderate level, viscosity of about 3500 mPas is not too high and it can be easily transferred by pumps. The starch composition is very stable at the whole tested temperature range 5-35° C. Viscosity increase at 5° C. was only 5% during storage of 120 days.

### Example 2: Dissolving of Cationic Waxy Maize Starch

238 g cationic waxy maize starch (dry content 88.0 wt-%, DS(Cat) 0.04) was slurried in 322 g tap water. pH of the slurry was 8.5 at 25° C. 440 g tap water was heated in a 2 liter kettle to 95° C. The starch was dissolved with Kady LT 2000 rotor stator high speed dispersion lab mill dispergator using the process described in the Example 1. The starch composition had the following characteristics: Dry content 21 wt-%, viscosity at 25° C. 4530 mPas and pH 6.6. A sample of the starch composition was diluted to 18% and 12% based on dry content. The starch compositions were stored at 5° C. and viscosities were monitored during storage. Results are in the table 3 and 4. Parallel starch composition samples were stored at 25° C., but that test was discontinued due to visually observed microbial spoilage.

TABLE 3
Viscosity of diluted starch compositions during storage at 5° C.
Viscosity of the composition at 25° C., mPas

| Storage time | Composition 1 | Composition 2 | Composition 3 |
|---|---|---|---|
| Days | 21 wt.-% | 18 wt.-% | 12 wt.-% |
| 0 | 4530 | 2448 | 720 |
| 42 | 4300 | 2640 | 710 |
| 63 | 3840 | 2550 | 695 |

TABLE 4
Viscosity change of starch composition during storage at 5° C.
Viscosity change compared to start value; %

| Storage time | Composition 1 | Composition 2 | Composition 3 |
|---|---|---|---|
| Days | 21 wt.-% | 18 wt.-% | 12 wt.-% |
| 0 | 0 | 0 | 0 |
| 42 | −5 | 8 | −1 |
| 63 | −15 | 4 | −3 |

Starch compositions of dissolved cationic waxy maize starch have all moderate or low viscosity at dry content range of 12-21 wt-%. Viscosities changes of the starch compositions were all at maximum 8% during 42 days storage at 5° C. and maximum 15% during 63 days storage at 5° C. Viscosity stability is a bit better at lower dry content 12% than higher dry content 21%.

### Example 3. Dissolving of Cationic Starch at Different Dry Content and Viscosity Stability Test

Cationic waxy potato starch (dry content, 82%, DS(Cat) 0.07) was dissolved with Kady LT 2000 rotor stator high speed dispersion lab mill dispergator with a method according to Example 1 to dry content of 21 wt-% (Starch composition 4). Starch composition 4 was diluted to 18% (Starch composition 5) and 12% (Starch composition 6) based on dry content. The same cationic starch was dissolved with Kady dispergator at the same method to dry content of 26 wt-%. The starch composition was diluted with water to 21% (Starch composition 7), 18% (Starch composition 8) and 12% (Starch composition 9) based on dry content. Samples of each Starch compositions were stored at 25° C. and at 5° C. for 40 days. Viscosity results are in the table 5 and 6.

TABLE 5
Viscosities of starch composites which are dispersed at dry content of 21 wt-%
and 26 wt-% and viscosity changes of diluted starch compositions during storage
at 25° C.
Viscosity of starch composition at 25° C. when stored at 25° C., mPas

| Storage time | Comp. 4 | Comp. 5 | Comp. 6 | Comp. 7 | Comp. 8 | Comp. 9 |
|---|---|---|---|---|---|---|
| Dry content in | 21 wt.-% | 21 wt.-% | 21 wt.-% | 26 wt.-% | 26 wt.-% | 26 wt.-% |
| dispergation | | | | | | |
| Days | 21% | 18% | 12% | 21% | 18% | 12% |
| 0 | 4240 | 2355 | 770 | 3980 | 2280 | 760 |
| 40 | 4400 | 2400 | 760 | 4040 | 2230 | 755 |
| Viscosity change | 4 | 2 | −1 | 2 | −2 | −1 |
| during storage, % | | | | | | |

TABLE 6
Viscosities of starch composites which are dispersed at dry content of 21 wt-%
and 26 wt-% and viscosity changes of diluted starch compositions during storage
at 5° C.
Viscosity of starch composition at 25° C. when stored at 5° C., mPas

| Storage time | Comp. 4 | Comp. 5 | Comp. 6 | Comp. 7 | Comp. 8 | Comp. 9 |
|---|---|---|---|---|---|---|
| Dry content in | 21 wt.-% | 21 wt.-% | 21 wt.-% | 26 wt.-% | 26 wt.-% | 26 wt.-% |
| dispergation | | | | | | |
| Days | 21% | 18% | 12% | 21% | 18% | 12% |
| 0 | 4240 | 2355 | 770 | 3980 | 2280 | 760 |
| 40 | 4300 | 2450 | 780 | 3980 | 2290 | 790 |
| Viscosity change | 1 | 4 | 1 | 0 | 0 | 4 |
| during storage, % | | | | | | |

The results show that dispersing concentration impacts slightly to viscosity of the starch composition. This indicates that some mechanical degradation of the starch molecules takes place during the treatment. If dispergation is arranged at higher concentration and the composition is diluted to lower concentration, then the viscosity is lower compared to starch composition which is dispersed straight at lower concentration. Viscosity stabilities of the starch compositions are good, viscosity changes are at maximum 4% during storage of 40 days at 25° C. or 5° C.

### Example 4: Dissolving of Cationic at High Concentration and Viscosity Stability Test at Different Starch Concentration

298 g cationic waxy potato starch (dry content 84.0 wt-%, DS(Cat) 0.07) was slurried in 417 g tap water. pH of the slurry was 8.6 at 25° C. 286 g tap water was heated in a 2 liter kettle to 95° C. The starch was dissolved Kady LT 2000 rotor stator high speed dispersion lab mill dispergator in the process described in the example 1. The cooled starch composition was preserved by adding 1.4 g CIT/MIT preservative product with active content 2.1 wt-%. The starch composition has the following characteristics: Dry content 25.5 wt.-%, viscosity at 25° C. 10 200 mPas and pH 8.3.

16 g polyvinylalcohol (PVA) product Mowiol 15-99 by Kuraray was dissolved in 137 g tap water by dosing the PVA product to 25° C. tap water under mixing, and heating the mixture to 95° C. while mixing and then continuing mixing the PVA at 95° C. for 15 min. The Mowiol 15-99 PVA-composition had the following characteristics: Dry content 10.6 wt.-%, viscosity at 25° C. 444 mPas and pH 5.7.

The starch composition was divided to 6 samples and they were diluted with water to different starch concentration. One sample contained starch 19.6 wt-% and PVA 0.4 wt-%, total dry matter was 20% and PVA content was 2 wt-% of dry matter. Compositions of diluted starch compositions (aqueous compositions of dissolved starch) are shown in the table 3. Viscosity and pH are determined, and the results are shown in the table 4.

TABLE 3
Compositions of diluted starch compositions.

| | | Cationic starch content | |
|---|---|---|---|
| Composition | Dry solids | (wt.-% of total dry | PVA (Mowiol 15-99) |
| No. | (wt-%) | solids) | (% of total dry solids) |
| 1 | 24 | 100 | |
| 2 | 22 | 100 | |
| 3 | 20 | 100 | |
| 4 | 18 | 100 | |
| 5 | 16 | 100 | |
| 6 | 20 | 98 | 2 |

TABLE 4
Viscosity and pH of the diluted starch compositions.

| Composition | Dry solids | Viscosity at 25° C. | |
|---|---|---|---|
| No. | (wt-%) | (mPas) | pH |
| 1 | 24 | 8700 | 8.3 |
| 2 | 22 | 6100 | 8.3 |
| 3 | 20 | 4090 | 8.3 |
| 4 | 18 | 2775 | 8.2 |
| 5 | 16 | 1805 | 8.5 |
| 6 | 20 | 3895 | 8.1 |

The starch compositions 1-6 were stored at 5° C. and viscosities at 25° C. were monitored during storage. Results are shown in the table 5. Viscosity changes compared to the start value were calculated. The viscosity change results are shown in the table 6.

TABLE 5
Viscosities of diluted starch compositions during storage at 5° C. Viscosity
of the composition at 25° C., mPas

| | Viscosity of the composition at 25° C., mPas | | | | | |
|---|---|---|---|---|---|---|
| | | | | | | Comp 6 |
| Storage time | Comp 1 | Comp 2 | Comp 3 | Comp 4 | Comp 5 | 20 wt.-%, with |
| Days | 24 wt.-% | 22 wt.-% | 20 wt.-% | 18 wt.-% | 16 wt.-% | PVA 15-99 |
| 0 | 8700 | 6100 | 4090 | 2775 | 1805 | 3895 |
| 9 | 8510 | 5760 | 4220 | 2720 | 1783 | 3995 |
| 31 | 7850 | 5090 | 3690 | 2440 | 1575 | 3500 |
| 44 | 7850 | 5260 | 3650 | 2495 | 1660 | 3850 |
| 72 | 7800 | 5130 | 3585 | 2340 | 1575 | 3745 |
| 154 | 8150 | 5400 | 3740 | 2550 | 1650 | 3800 |

TABLE 6
Viscosity change of diluted starch compositions during storage at 5° C.

| | Viscosity change compared to start value, % | | | | | |
|---|---|---|---|---|---|---|
| | | | | | | Comp 6 |
| Storage time | Comp 1 | Comp 2 | Comp 3 | Comp 4 | Comp 5 | 20 wt.-%,with |
| Days | 24 wt.-% | 22 wt.-% | 20 wt.-% | 18 wt.-% | 16 wt.-% | PVA 15-99 |
| 0 | 0 | 0 | 0 | 0 | 0 | 0 |
| 9 | −2 | −6 | 3 | −2 | −1 | 3 |
| 31 | −10 | −17 | −10 | −12 | −13 | −10 |
| 44 | −10 | −14 | −11 | −10 | −8 | −1 |
| 72 | −10 | −16 | −12 | −16 | −13 | −4 |
| 154 | −6 | −11 | −9 | −8 | −9 | −2 |

Viscosity changes during storage at 5° C. were small. Maximum change in all dilution level were at maximum 17%. Composition 6 which contained 2 wt-% PVA of dry matter had better viscosity stability than composition 3, which had the same total dry matter, but no PVA.

### Example 5: Method for Dissolving Cationic Waxy Starch with Recirculation

264 kg tap water was fed into a 800 liter tank, “dissolution tank”, was equipped with a jacket for heating and cooling, and a circulation line form the bottom of the reactor and back to the top of the dissolution tank. The circulation line was equipped with a circulation pump (Mohno pump-type) to circulate the liquid in the reactor through the circulation line, “circulation pump”. The circulation line was equipped also with a metal pipe which has a shape of letter “Y”, and contains two inlets and one outlet, “Y-bar”. The circulation line was connected to the in-let 1 of the Y-bar. Diameter of Y-bar was 5 cm and length 120 cm. Atrex CD550 G30 rotor-rotor dispergator was connected to the circulation line after Y-bar and liquid goes back to the reactor after Atrex-treatment. The lines and the Y-Bar were insulated to avoid cooling of the material during circulation.

150 kg cationic waxy potato starch (DS 0.07, CD 0.4 meq/g measured at pH 7, dry content 82 wt.-%, pH of 35 wt.-% slurry 7,5, dry starch 123 kg) was slurried in 201 kg water in a 800 liter slurry tank equipped with an agitator to get a starch slurry of 35 wt.-%. Agitator speed was about 60 rpm during slurrying stage. The slurry tank was equipped with a transfer line which contain a transfer pump (Mohno type pump), “slurry pump”. The line was connected to the inlet 2 of the Y-bar. Starch slurry gets mixed with the reactor liquid in Y-bar and then the mixture enters Atrex dispergator.

Water in the reactor was heated to 87° C. with a jacket. Circulation pump flow was adjusted with water to 8.6 kg/min. Atrex frequency inverter 1 and 2 were both adjusted to 50 Hz. Slurry pump flow was adjusted to 1.8 kg/min. Starch was gelatinized when the starch slurry contacts circulation liquid in the Y-bar. Delay time of the gel was about 14 sec before the formed gel enters Atrex. Temperature of the gel was about 77-80° C., after Atrex-treatment.

After 60 min processing Atrex frequency inverters were increased to 67 Hz. When all of the starch slurry was pumped into Y-bar, heating of the reactor was stopped. The liquid in the reactor was circulated for 30 min with 70 Hz frequency of both inverters. The dissolved starch composition was cooled to 25° C. with a jacket. Reactor and slurry tank were not pressurized vessels and they didn't contain condenser and thus a part of the water was evaporating during the dissolving process.

The composition was cooled with a jacket. The composition contains the following characteristics: Dry solids (starch content) 22.2 wt.-%, Viscosity 6300 mPas at 25° C., pH 7.8.

### Example 6: Evaluation of Homogeneity

Cationic starch powder product was dissolved according to method described in the Example 1. In order to test homogeneity of the solution (composition), gel content of the composition was determined by filtration test. A 150 g sample of the starch composition (concentration about 21 wt.-%) was diluted with 200 g de-ionized water. The solution was put to Millipore Amicon cell (by Millipore), equipped with a magnetic stirrer and 300 μm plastic wire and above that pre-dried filter paper (105° C., 20 h), Whatman 54 by Whatman which has pore size of about 22 μm. Stirring speed was adjusted to 200 rpm. The solution was filtered through the filter paper by +3 bar pressure. The filter was then rinsed with 300 g deionized water using +0.2 bar pressure. The filter paper with the gel was dried for 20 h at 105° C. The dried paper was weighed and the gel content of the starch composition (˜21%) was calculated. The results are shown in table 7.

TABLE 7
Starch gel content as dry

| | | | | | | Gel | Gel |
|---|---|---|---|---|---|---|---|
| | | | | | | content* | content* |
| | | | Dry | | | (wt-% of | (mg/kg |
| | Starch | | content | Viscosity | | starch | starch |
| Starch | samples | DS | (wt-%) | (cP) | pH | solution) | solution) |
| X670 | Cationic | 0.07 | 20.91 | 4260 | 6.86 | 0.0084 | 84 |
| | waxy | | | | | | |
| | potato | | | | | | |
| Optipro | starch | | | | | | |
| 650 | Cationic | 0.082 | 20.74 | 3470 | 6.5 | 0.0114 | 114 |
| | waxy | | | | | | |
| | maize | | | | | | |
| | starch | | | | | | |

*Gel content as dry

1. An aqueous composition of dissolved starch, wherein the composition comprises at least 12 weight-% of dissolved cationic starch having
a viscosity of at least 500 mPas, as measured at 25° C. from 12 weight-% aqueous solution using Brookfield LV-DV1 viscometer,
degree of cationic substitution of 0.02-0.15, preferably 0.03-0.09, and
an amylopectin content of at least 90 weight-% of dry starch,
and the composition has a viscosity of 500 to 15 000 mPas as measured at 25° C. using Brookfield LV-DV1 viscometer.

2. The composition of claim 1, wherein said composition is substantially homogeneous.

3. The composition of claim 1, wherein the cationic starch has a viscosity of 500-2000 mPas, preferably of 500-1500 mPas, as measured at 25° C. from 12 weight-% aqueous solution using Brookfield LV-DV1 viscometer.

4. The composition of claim 1, wherein the composition comprises 12 to 30 weight-% of the dissolved cationic starch.

5. The composition of claim 1, wherein the starch has a charge density of 0.1 to 1.0 meq/g (dry solids), preferably 0.2 to 0.8 meq/g (dry solids), measured at pH 7.

6. The composition of claim 1, wherein the cationic starch has an amylopectin content of at least 95 weight-%, preferably at least 98 weight-%, of dry starch.

7. The composition of claim 1, wherein the cationic starch is cationic waxy starch.

8. The composition of claim 1, wherein the composition has a viscosity of 1000 to 12 000 mPas, or 2000 to 10 000 mPas, as measured at 25° C. using Brookfield LV-DV1 viscometer.

9. The composition of claim 1, wherein the viscosity of the composition after storage of at least 40 days or at least 60 days, preferably of at least 90 days, more preferably of at least 120 days, at a temperature of 25° C., differs at most 30%, preferably at most 20%, more preferably at most 15%, from day 0 viscosity of the composition, as measured at 25° C. using Brookfield LV-DV1 viscometer.

10. The composition of claim 1, wherein the viscosity of the composition after storage of 10 days or of 20 days, preferably of 30 days, more preferably of 60 days, at a temperature of 5° C., differs at most 40%, preferably at most 30%, more preferably at most 20%, from day 0 viscosity, as measured at 25° C. using Brookfield LV-DV1 viscometer.

11. The composition of claim 1, wherein the composition has a pH of at least 4, preferably in the range of 4-10, more preferably in the range of 4-9.

12. The composition of claim 1, wherein the composition further comprises up to 20 weight-%, based on weight of dissolved cationic starch (dry/dry), of one or more additives, such as preservatives, biocides, stabilizers, antioxidants, pH adjusting agents, buffers or the like.

13. The composition of claim 1, wherein the composition comprises at least 20 weight-% of dissolved cationic starch having
a viscosity of at least 500 mPas, as measured at 25° C. from 12 weight-% aqueous solution using Brookfield LV-DV1 viscometer,
degree of cationic substitution of 0.02-0.15, preferably 0.03-0.09, and
an amylopectin content of at least 90 weight-% of dry starch,
and the composition has a viscosity of 3000 to 6 000 mPas as measured at 25° C. using Brookfield LV-DV1 viscometer.

14. The composition of claim 1, wherein said composition is obtained by
a. providing a feed of an aqueous starch slurry having a temperature at least 5° C., preferably at least 10° C. below the gelatinization temperature of the starch (used in said slurry); and
b. bringing said feed (“slurry feed”) together with an aqueous feed having an elevated temperature being at least 60° C. to form a mixed feed; and
c. subjecting said mixed feed to a dispergation to reduce the viscosity of said mixed feed.

15. The composition of claim 1, wherein said composition has a gel content less than 0.3 wt.-%, preferably less than 0.2 wt.-% and more preferably less than 0.1 wt.-% as dry.

16. A method to make paper, comprising a step of adding Use of the composition according to claim 1 as a paper strength agent, as a papermaking retention and drainage aid, as a flocculant, as a paper sizing agent, as a protective colloid, as an emulsifier, as a rheology modifier, and/or as a binder.

17. A sizing formulation, comprising the composition of claim 1.

18. The sizing formulation of claim 17, wherein the formulation is an ASA emulsion.
